(19) United States
(12) Patent Application Publication
(10) Pub. No.: US 2008/0240520 A1
(43) Pub. Date: Oct. 2, 2008

(54) Imaging apparatus, display control method and recording medium

(75) Inventor: Akira Miyata, Kodaira-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/074,796

(22) Filed: Mar. 6, 2008

(30) Foreign Application Priority Data
Mar. 28, 2007 (JP) 2007-083185

(51) Int. Cl. G06K 9/00

(52) U.S. Cl. 382/118; 382/190

(57) ABSTRACT

In a digital camera 1, when a shutter key is operated, a CPU 13 executes the shooting process (Step S103), extracts a face image from this shot image (Step S104), and judges whether the extracted face image is a face image registered in a face image registration table (Step S106). When judged that the registered face image is contained in the image which has just been shot, the CPU 13 turns ON an already-shot flag for the registered face image judged to be contained in the face image registration table (Step S107). Also, the CPU 13 detects a face image that has not been shot yet which is a registered face image for which the already-shot flag F is in the OFF state in the face image registration table (Step S108), and displays the detected face image that has not been shot yet in the display section 14 (Step S109).

### CROSS-REFERENCE TO RELATED APPLICATION

This application is based upon and claims the benefit of priority from the prior Japanese Patent Application No. 2007-083185, filed Mar. 28, 2007, the entire contents of which is incorporated herein by reference.

### BACKGROUND OF THE INVENTION

1. Field of the Invention

The present invention relates to an imaging apparatus, a display control method, and a recording medium for shooting a subject after registering subjects in advance.

2. Description of the Related Art

Conventionally, cameras are known which drive a shooting lens for an entire range, detect peaks of a plurality of focus point evaluation values by contrast method, and perform shooting at individual positions corresponding thereto.

Accordingly, even in the case of shooting a scene where a plurality of persons are present at positions with different distances from the camera, such as a snapshot at a party or a group photo, shooting at the individual lens positions as described above enables taking a photo with the faces of individual persons being in focus. In this way, use of the conventional camera as described above enables taking a photo with faces of the individual persons being in focus as a snapshot at a party or a group photo.

However, the judgment on whether photos are shot for all participants at the party depends solely on the memory of the photographer. As a result of this, there is a drawback of omission in shooting in which some participants do not appear on any of the photos taken.

### SUMMARY OF THE INVENTION

The present invention has been conceived in light of the foregoing situations, and is to provide an imaging apparatus, a display control program and a display control method which enables shooting subjects without omission.

In order to achieve the above-described purpose, in accordance with one aspect of the present invention, there is provided an imaging apparatus comprising: a subject memory section which stores a subject; an imaging section which shoots an image; an image recording section which records an image shot by the imaging section; a judging section which judges a state in which an image containing the subject stored in the subject memory section is recorded in the image recording section, and a display section which displays a result of being judged by the judging section.

In accordance with another aspect of the present invention, there is provided an imaging apparatus comprising: a subject memory section which stores a subject; an imaging section which shoots; an image recording section which records an image; a first judging section which judges whether an image containing a subject stored in the subject memory section has been stored in the image recording section; a second judging section which judges whether a subject stored in the subject memory section is present in an image which is shot by the imaging section; and a recording control section which acquires the image shot by the imaging section and records the image in the image recording section, when judged that the subject is present by the second judging section and judged that an image containing the subject has not been stored in the image recording section by the first judging section.

In accordance with another aspect of the present invention, there is provided a computer-readable storage medium having a program of an imaging apparatus including a subject memory section which stores a subject, an imaging section which shoots, and an image recording section which records an image shot by the imaging section stored thereon that is executable by a computer, comprising: a judgment process which judges a state in which an image containing the subject stored in the subject memory section is recorded in the image recording section, and a display control process which displays a result of being judged by the judging process.

In accordance with another aspect of the present invention, there is provided a display control method in an imaging apparatus including a subject memory section which stores a subject, an imaging section for shoots; and an image recording section which records an image shot by the imaging section, the method comprising: a judging step which judges a state in which an image containing the subject stored in the subject memory section is recorded in the image recording section; and a display step which displays the result detected by the detection step.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram of a digital camera that is common to various embodiments of the present invention;

FIG. 2A is a diagram showing a menu screen in a face registration mode process;

FIG. 2B is a diagram showing a display screen in the face registration mode process;

FIG. 2C is a schematic drawing showing a face image registration table according to a first embodiment of the present invention;

FIG. 2D is a diagram showing a display screen in the face registration mode process;

FIG. 2E is a schematic drawing showing the face image registration table according to the first embodiment of the present invention;

FIG. 3 is a flowchart showing a process procedure of the face registration mode process;

FIG. 4 is a flowchart showing a process procedure of a shooting mode according to the first embodiment of the present invention;

FIG. 5A is a diagram showing a display screen in the shooting mode according to the first embodiment of the present invention;

FIG. 5B is a diagram showing a display screen in the shooting mode according to the first embodiment of the present invention;

FIG. 6A is a schematic drawing showing a face image registration table according to a second embodiment *² the present invention;

FIG. 6B is a diagram showing a display screen in a shooting mode according to the second embodiment of the present invention;

FIG. 7 is a flowchart showing a process procedure of the shooting mode according to the second embodiment of the present invention;

FIG. 8 is a flowchart showing a process procedure of a shooting mode according to a third embodiment of the present invention;

FIG. 9A is a diagram showing a display screen in the shooting mode according to the third embodiment of the present invention;

FIG. 9B is a diagram showing a display screen in the shooting mode according to the third embodiment of the present invention;

FIG. 9C is a diagram showing a display screen in the shooting mode according to the third embodiment of the present invention;

FIG. 9D is a diagram showing a display screen in the shooting mode according to the third embodiment of the present invention;

FIG. 10 is a flowchart showing a process procedure of a shooting mode according to a fourth embodiment of the present invention;

FIG. 11A is a diagram showing a display screen in the shooting mode according to the fourth embodiment of the present invention;

FIG. 11B is a diagram showing a display screen in the shooting mode according to the fourth embodiment of the present invention;

FIG. 12A is a diagram showing a memory configuration according to a fifth embodiment of the present invention;

FIG. 12B is a diagram showing a memory configuration according to the fifth embodiment of the present invention;

FIG. 12C is a diagram showing an example of a shot image according to the fifth embodiment of the present invention;

FIG. 12D is a diagram showing an example of a shot image according to the fifth embodiment of the present invention;

FIG. 12E is a diagram showing an example of a shot image according to the fifth embodiment of the present invention;

FIG. 12F is a diagram showing an example of a shot image according to the fifth embodiment of the present invention;

FIG. 12G is a diagram showing an example of a shot image according to the fifth embodiment of the present invention;

FIG. 13 is a flowchart showing a process procedure of a shooting mode according to the fifth embodiment of the present invention;

FIG. 14 is a flowchart showing a process procedure of a shooting mode of according to a sixth embodiment the present invention;

FIG. 15A is a diagram showing a state at automatic shooting in the sixth embodiment of the present invention;

FIG. 15B is a diagram showing a state at automatic shooting in the sixth embodiment of the present invention;

FIG. 15C is a diagram showing a state at automatic shooting in the sixth embodiment of the present invention; and

FIG. 15D is a diagram showing a state at automatic shooting in the sixth embodiment of the present invention.

### DETAILED DESCRIPTION OF THE PREFERRED EMBODIMENTS

An embodiment of the present invention will hereinafter be described with reference to the drawings.

### A. First Embodiment

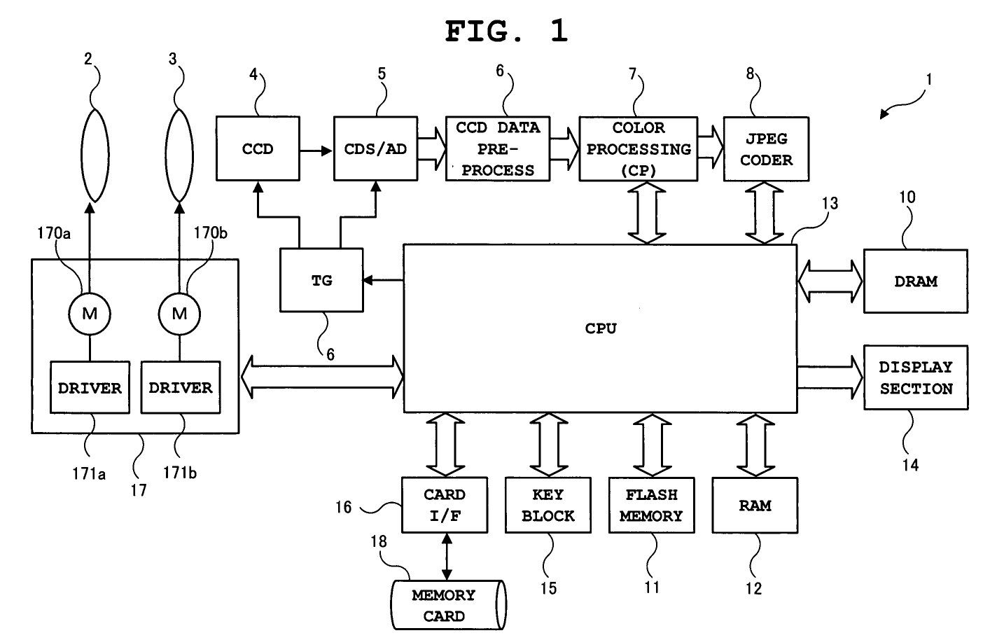

FIG. 1 is a block diagram of a digital camera 1 that is common to various embodiments of the present invention. This digital camera 1 is provided with an automatic focus function (AF function), and includes a focus lens 2, a zoom lens 3, a charge-coupled device (CCD) 4, a CDS/AD block 5, a timing generator (TG) 6, a CCD data pre-process block 7, a color processing (CP) block 8, a Joint Photographic Experts Group (JPEG) coder 9, a dynamic random access memory (DRAM) 10, a built-in flash memory 11, a random access memory (RAM) 12, a central processing unit (CPU) 13, a display section 14, a key block 15, a card interface 16, and a motor driver block 17. The card interface 16 is connected to a memory card 18 which is detachably mounted on a card slot of a camera body.

Each of the focus lens 2 and the zoom lens 3 respectively include a lens group not shown. The motor driver block 17 includes a focus motor 170a, a zoom motor 170b and motor drivers 171a and 171b. The focus motor 170a drives the focus lens 2 in the optical axis direction, and the zoom motor 170b drives the zoom lens 3 in the optical axis direction. The motor drivers 171a and 171b respectively drive the focus motor 170a and the zoom motor 170b in accordance with a control signal sent from the CPU 13. Note that, both the focus motor 170a and the zoom motor 170 are stepping motors.

The CCD 4 photo-electrically converts a subject image projected via the focus lens 2 and the zoom lens 3 and outputs the projected subject image as an imaging signal. The TG 6 generates a timing signal of a predetermined frequency so as to drive the CCD 4. The CDS/AD block 5 samples a signal outputted from the CCD 4 so as to remove noise and converts the signal to a digital signal. The CCD data pre-process block 7 executes data process such as brightness signal process on the digitalized imaging signal. The color processing (CP) block 8, to generate image data of Y, Cb, Cr, executes color process such as color separation on the image signal which has undergone the brightness signal-process. The DRAM 10 sequentially stores the image data of Y, Cb, Cr that has undergone the color process.

The display section 14 includes a color LCD and a driver circuit that drives it. In the shooting stand-by state in which a shooting mode has been set and a shutter key has not been depressed, the display section 14 displays a through image based on an image data which has been loaded from the CCD 4 and accumulated in the DRAM 10 and which is equivalent to the amount of 1 frame (screen). In the state where a replay mode has been set, the display section 14 displays a recorded image based on the image data which has been read from the memory card 18 and which has been expanded.

The JPEG coder 9 compresses the image data inputted from the color processing (CP) block 8 into the JPEG format when the image is recorded (when shooting process is executed). The memory card 18 records the compressed image data that has been sent via the card interface 16. The recorded image data is read out when the recorded image is replayed, and after expanded by the JPEG coder 9, displayed in the display section 14. In addition, the key block 15 includes various operation keys such as a mode selection key that is used for selecting various modes such as a shooting mode, a replay mode, a face image registration mode and related modes, a SET key, a shutter key, a setting key for setting an aperture and a shutter speed, a zoom key that is used for changing a zoom magnification, and related keys. This key block 15 sends the CPU 13 an operational signal in accordance with key operation. Furthermore, the shutter key is provided with a so-called half-shutter function and is configured to enable a half-depression operation for giving advance notice of shooting and a full-depression operation for instructing shooting.

The flash memory 11 stores programs and various data necessary for control of the digital camera 1 executed by the CPU 13, that is, AF control, AE control, AWB control, or related controls. The flash memory 11 also stores a control program for executing a control shown in a flowchart to be described, and related programs. The CPU 13 runs the RAM 12 as a working memory in accordance with an operational signal from the key block 15 and the above-described program.

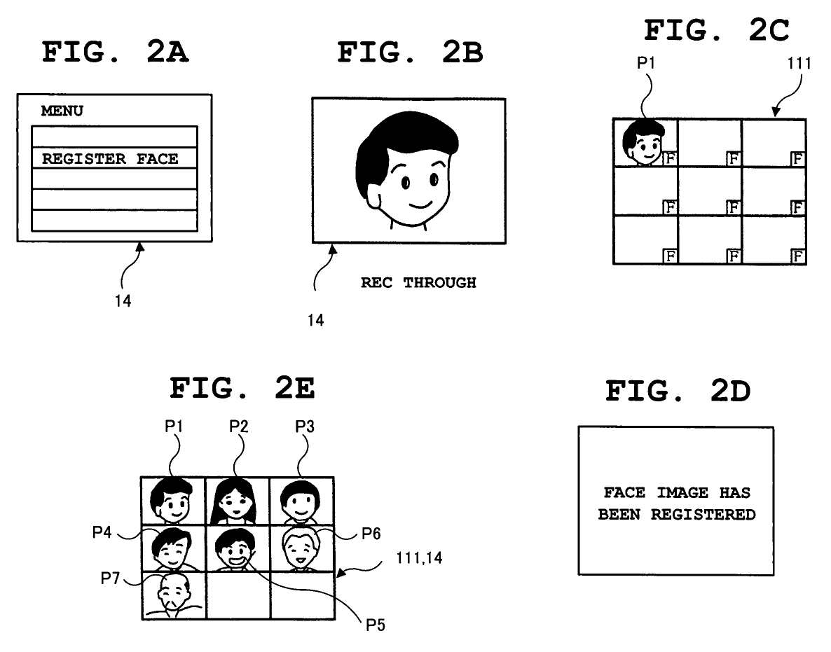

In addition, the flash memory 11 is provided with a face image registration table 111 as shown in FIG. 2C. In the face image registration table 111, a plurality of registration areas for storing a face image is provided, and an already-shot flag F is provided for each registration area. This already-shot flag F indicates that, when in the OFF state, a shot image containing a registered face image that has been stored in the area has not been recorded in the memory card 18, and when in the ON state, a shot image containing the registered face image has been recorded in the memory card 18.

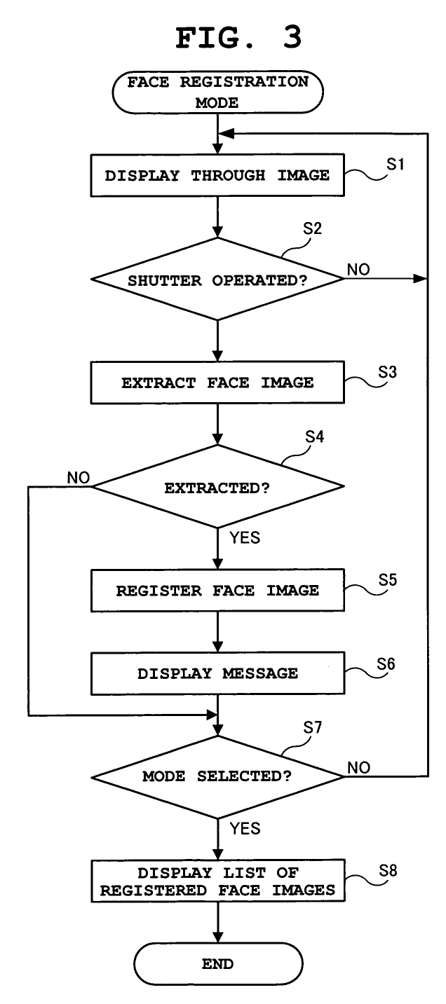

The operation according to the present embodiment of the digital camera 1 with the configuration as described above will hereinafter be described. When a user operates the mode selection key provided in the key block 15 after turning the power ON, a menu screen as shown in FIG. 2A is displayed in the display section 14. When the user selects “REGISTER FACE” on the menu screen and operates the SET key, the mode is set to the face registration mode. Subsequently, the CPU 13 runs in accordance with the program as described above, thereby executing the processes as shown in a flowchart of FIG. 3. Specifically, the CPU 13 displays a through image based on an image data which has been loaded from the CCD 4 and accumulated in the DRAM 10 and which is equivalent to the amount of 1 frame (screen) in the display section 14 (Step S1). Accordingly, at this time, when the user aims the digital camera 1 at a face of a person the user wants to shoot without omission, a face image P1 of the person is displayed in the display section 14, as shown in FIG. 2B.

Next, the CPU 13 judges whether the shutter key has been operated (Step S2). When the user operates the shutter key in this state, the judgment at Step S2 becomes YES. Accordingly, the CPU 13 proceeds from Step S2 to Step S3, where the CPU 13 executes the face image extraction process.

In the process at Step S3, in accordance with the operation of the shutter key, the CPU 13 extracts a face area which corresponds to a face part of a human body from the shot image that has been stored in the DRAM 10. In extracting the face area, the CPU 13 detects an area of a human face, based on an RGB value, an HSV value (H: Hue, S: Saturation, V: Value of Brightness) or the like in a flesh color area within the shot image. For example, when a distribution data on a hue and a saturation of flesh-colored image data are sampled, it is known that many flesh-colored image data are distributed in the range of approx. 6° to 38° in the hue circle, while the saturation is distributed in a wide range. Use of such distribution property enables detecting the face area of the subject such as by defining a hue in the range of approx. 6° to 38° as a flesh color of a human face or the like based on the HSV value. When the CPU 13 has detected the face area in this manner, it extracts the entire area including the face area and a head part above the face area as the face image.

Note that, as the face image extraction process at Step S103, instead of the method described above, other partial image extraction methods may be used.

Next, the CPU 13 judges whether a face image has been extracted by the extraction process at Step S3 (Step S4). When judged that a face image has not been extracted, the CPU 13 proceeds to Step S7. When judged that a face image has been extracted, the CPU 13 executes the face image registration process, and stores the face image that has been extracted at the Step S3 in a free registration space of the face image registration table 111 (Step S5). Accordingly, as shown in FIG. 2C, by the process at Step S5, the face image P1 of the person that has been shot this time is registered in the free registration space of the face image registration table 111.

Subsequently, the CPU 13 executes the message display process (Step S6), where the CPU 13 displays a message such as “FACE IMAGE HAS JUST BEEN REGISTERED” as shown in FIG. 2D in the display section 14. Further, the CPU 13 judges whether the mode selection from the face registration mode to another mode has been made (Step S7), and when judged that the mode selection has not been made, the CPU 13 repeats the loop from Step S1 to Step S7 until the mode selection is made. Accordingly, the user can register face images P1 to P7 of 7 persons in the face image registration table 111 as shown in FIG. 2E, as a result of the user having performed shooting in the state of this face registration mode.

Consequently, the user can register the face images easily by operating the shutter key in the same manner as when performing ordinary shooting.

Thus, in the case where the user wants to shoot persons such as family members, friends without omission, after completing registration of the face images P1 to P7 of the persons, the user performs the mode selection from the face registration mode to another mode through operation of the key block 15. As a result of this, the judgment at Step S7 becomes YES, and the CPU 13 proceeds from Step S7 to Step S8. At Step S8, after executing the face image list display process, the CPU 13 ends the process in accordance with the flow.

At this time, in the face image list display process at the above-described Step S8, as shown in FIG. 2E, the CPU 13 displays, in the display section 14, a list of the face images that are registered in the face image registration table 111. Accordingly, in the case where the user wants to shoot persons without omission, the user can check whether the face images of all persons have been registered by viewing the list of the face images displayed in the display section 14. As a result of the checking, if an image which needs to be registered is still present, all the user has to do is to set the face image registration mode again and perform the shutter operation in the similar manner as described above.

In the present embodiment, the face image should be registered by means of shooting a face of a person. In this case, the user may instead set the replay mode, display in the display section 14 the image which has been recorded in the memory card 18, specify the area of the face image contained in this image, and register the face images in the face image registration table 111. As a result of this, the user can register the face image without executing the shooting process.

In addition, in the present embodiment, the face image shot in the face image registration mode should be recorded in the face image registration table 111. However, the face image may be recorded also in the memory card 18 as is the case with ordinary shooting. As a result of this, the user can, for example, look at the face image which was shot for face image registration by replaying and displaying it as is the case with the image which is ordinarily shot.

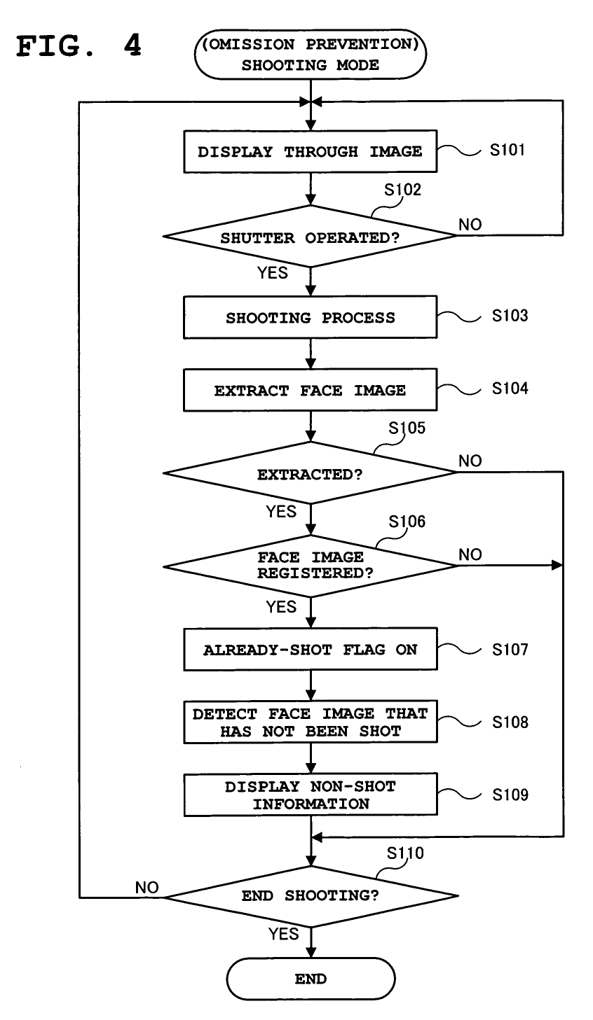

In the meantime, when the user sets a mode to the omission prevention shooting mode or the ordinary shooting mode, the CPU 13 runs in accordance with the program as described above, thereby executing the processes as shown in the flowchart of FIG. 4. Specifically, the CPU 13 displays a through image based on an image data which has been loaded from the CCD 4 and accumulated in the DRAM 10 and which is equivalent to the amount of 1 frame (screen) in the display section 14 (Step S101) Next, the CPU 13 judges whether the shutter key has been operated (Step S102). When judged that the shutter key has been operated, the CPU 13 executes the shooting process (Step S103), and records the JPEG-compressed image data in the memory card 18.

Next, the CPU 13 executes the face image extraction process described above to extract the face image from the shot image which is the image data recorded in the memory card 18 (Step S104), and judges whether a face image has been extracted by the process at Step S104 (Step S105). When judged that a face image has not been extracted, the CPU 13 proceeds to Step S109. When judged that a face image has been extracted, the CPU 13 judges whether the extracted face image is a face image registered in the face image registration table 111 (Step S106).

At the judgment at Step S106, the CPU 13 performs matching of the face area extracted from the shot image which has just been recorded this time in the memory card 18 with the individual face images recorded in the face image registration table 111 to compare with, or performs calculation of degree of correlation, degree of similarity, similarity distance, difference and the like. Specifically, the CPU 13 calculates the characteristic data of the individual face images recorded in the face image registration table 111 which serves as the template, and performs template matching with the shot image or compares the individual characteristic data to calculate degree of correlation, degree of similarity, similarity distance and the like. Then, when these calculated values are not less than predetermined values, the CPU 13 judges that the registered face image is contained in the shot image (Step S106; YES). When the calculated values are less than predetermined values, the CPU 13 judges that the registered face image is not contained in the shot image (Step S106; NO).

Note that, as the registered face judgment process at Step S106, instead of the method as described above, other judgment process methods may be used.

Next, when the registered face image is not contained in the shot image which has just been recorded this time in the memory card 18 (Step S106; NO), the CPU 13 proceeds to Step S110 without executing the processes at Steps S107 to S109. In addition, when the registered face image is contained in the shot image which has just been recorded this time in the memory card 18, the CPU 13 turns ON the already-shot flag F of the registered face images judged to be contained in the face image registration table 111 (Step S107).

At this time, when a plurality of registered face images are contained in the shot image, the CPU 13 turns ON the already-shot flag F of each of the registered face images. On the contrary, even in the case where a plurality of registered face images are contained in the shot image, the already-shot flag F of only one registered face image may be turned ON.

Subsequently, the CPU 13 detects a face image that has not been shot (non-shot face image) which is a registered face image for which the already-shot flag F is in the OFF state in the face image registration table 111 (Step S108), and displays the detected face image in the display section 14 (Step S109).

Here, “a non-shot face image” means the image of a face corresponding to the image subject which has not been shot yet.

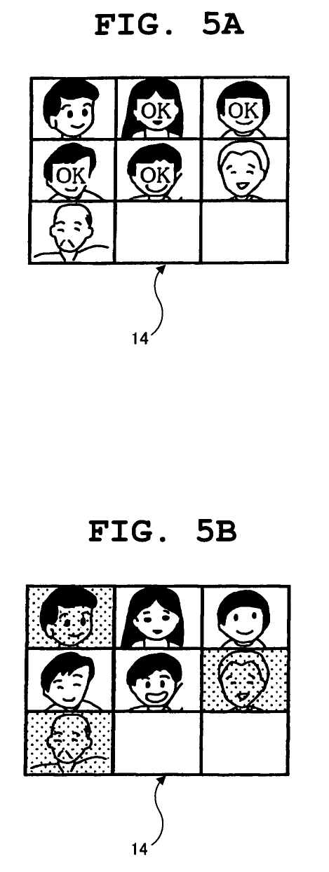

By the process at Step S109, for example, as shown in FIG. 5, the CPU 13 displays the registered face image that has not been shot with the already-shot flag F being OFF as it is, and superimpose “OK” on the registered face image that has been shot with the already-shot flag F being ON. Alternatively, as shown in FIG. 5B, the CPU 13 displays the registered face image that has not been shot with the already-shot flag F being OFF as it is, and the registered face image that has been shot with the already-shot flag F being ON in a shaded manner.

Accordingly, in the present embodiment, every time an image containing the registered face image is shot, the registered face image that has not been shot is displayed in the display section 14. Thereby the user can check a person (i.e., subject) who has not been shot every time the user shoots a person who has already been registered. Accordingly, the user is given the strong impression of the person who has not been shot, and thus the user thereafter makes a conscious effort to preferentially shoot the person who has not been shot. As a result, the user can shoot without omission the persons who have been registered in advance.

Next, at Step S110 subsequent to Step S109, the CPU 13 judges whether a shooting end instruction, such as the mode selection from the shooting mode to another mode, has been made. The CPU 13 repeats the processes starting from Step S101 until the shooting end instruction is made, and upon the shooting end instruction, the CPU 13 ends the process in accordance with the flowchart.

Note that, in the present embodiment, the CPU 13 should perform the shooting process to record the shot image in the memory card 18 at Step S103, and subsequently should judge whether the registered face image is contained in the shot image which is recorded at Step S106. However, the CPU 13 may save the shot image in the DRAM 10 when the shutter key is operated, and may record the shot image in the memory card 18 when judged that the registered face image is contained in the shot image. On the other hand, when judged that the registered face image is not contained in the shot image, the CPU 13 may erase the shot image stored in the DRAM 10 without recording it in the memory card 18.

As a result of this, only the shot images that contain the registered face image can be recorded in the memory card 18.

In addition, in the present embodiment, the CPU 13 should proceed to Step S110 when the judgment at Step S106 is NO. However, the CPU 13 may proceed to Step S108. In this case, even when the registered face image is not contained in the shot image, the registered face image that has not been shot should be displayed every time shooting is performed. This enables prompting the user to early perform shooting of persons registered in advance.

Furthermore, the time point when the CPU 13 executes display of non-shot information at Step S109 is not limited to the time immediately after the shooting process. Instead, the time point may be other time points, such as when the power is turned ON, the time point when the shooting mode is set for the first time of the day, the time point when the shutter key is operated for the first time of the day. In addition, display of non-shot information at Step S109 is not limited to the display forms as shown in FIG. 5A, FIG. 5B. Instead, what has been shot and what has not been shot may be differentiated in another display form, or only the registered face image that has been shot may be displayed

### B. Second Embodiment

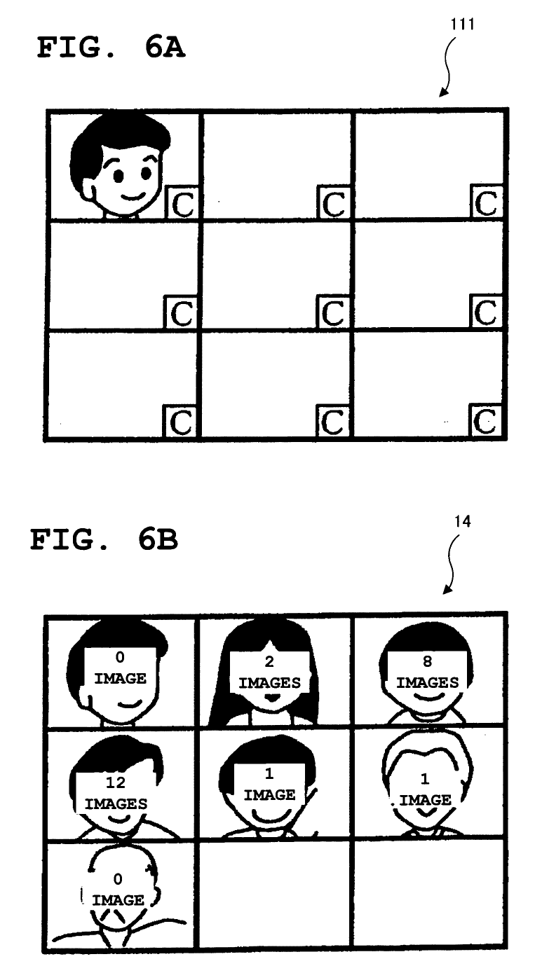

FIG. 6A is a diagram showing a face image registration table 111 according to a second embodiment of the present invention. The face image registration table 111 is provided with a plurality of registration areas for storing face images, and a counter C is provided for each registration area. This counter C, with an initial value “0”, should be counted up every time an image containing a registered face image stored in the area is shot.

Note that, in various embodiments as shown below, the face registration mode process is performed in the same procedure as that in the first embodiment as shown in the flowchart of FIG. 3.

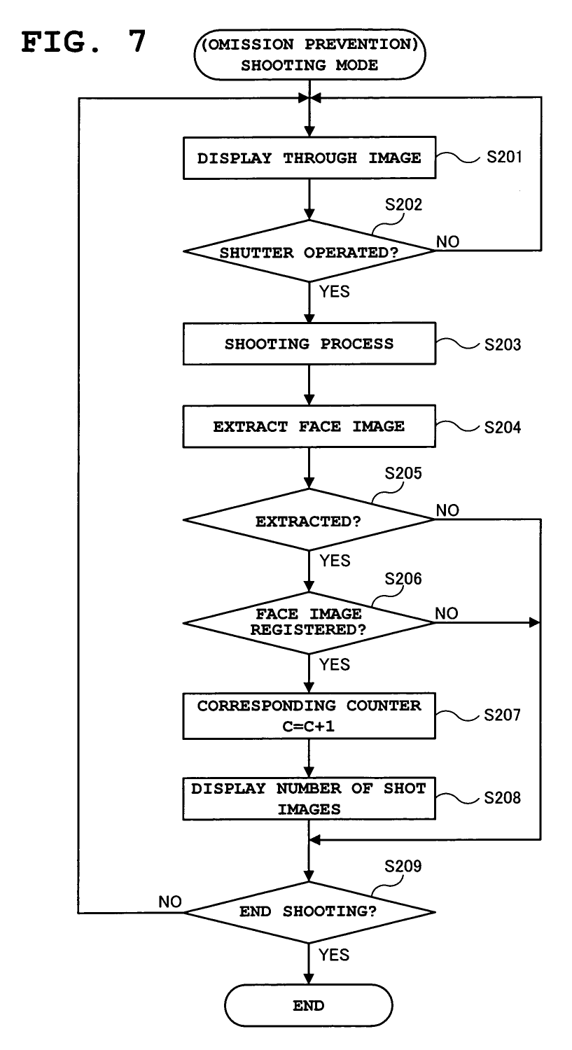

FIG. 7 is a flowchart showing the process procedure of the shooting mode process in the present embodiment. When a user sets a mode to the omission prevention shooting mode or the ordinary shooting mode, the CPU 13 runs in accordance with the program as described above, thereby executing the processes as shown in the flowchart. Specifically, the CPU 13 displays a through image based on an image data, which is equivalent to the amount of 1 frame (screen), loaded from the CCD 4 and accumulated in the DRAM 10 in the display section 14 (Step S201). Next, the CPU 13 judges whether the shutter key has been operated (Step S202). When judged that the shutter key has been operated, the CPU 13 executes the shooting process (Step S203), and records the JPEG-compressed image data in the memory card 18.

Next, the CPU 13 executes the face image extraction process as described above to extract the face image from the shot image which is an image data recorded in the memory card 18 (Step S204). In addition, the CPU 13 judges whether a face image has been extracted by the process at this Step S204 (Step S205), and when judged that a face image has not been extracted, the CPU 13 proceeds to Step S209. When judged that a face image has been extracted, the CPU 13 judges whether the extracted face image is one of the face images that are registered in the face image registration table 111 (Step S206, and when judged that the registered face image is not contained in the shot image which has just been recorded this time in the memory card 18 (Step S206; NO), the CPU 13 proceeds to Step S209 without executing the processes at Steps S207 and S208. When judged that the registered face image is contained in the shot image which has just been recorded this time in the memory card 18, the CPU 13 counts up the counter C for the registered face image judged to be contained in the face image registration table 111 (Step S207).

At this time, when a plurality of registered face images are contained in the shot image, the CPU 13 counts up the counter C of each of the registered face images. On the contrary to this, even when a plurality of registered face images are contained in the shot image, the CPU 13 may count up the counter C of only one of the registered face images.

Subsequently, the CPU 13 executes the number of shot images display process (Step S208). By the process at Step S208, as shown in FIG. 6B, the CPU 13 displays the face images registered in the face image registration table 111 in the display section 14, and superimpose the corresponding counter C value on each face image.

Accordingly, in the present embodiment, the number of the shot images that contain the registered face image is displayed for each registered face image in the display section 14, every time an image containing the registered face image is shot. Thereby, the user can check the number of shot images for each registered subject, every time the user shoots persons registered in advance. Thus, the user is given the strong impression of the number of shot images for each registered subject, and thereafter makes a conscious effort to preferentially shoot the person who has not shot or the person with a small number of shot images. As a result, the user can perform shooting of persons registered in advance without omission and evenly.

Next, at Step S209 subsequent to Step S208, the CPU 13 judges whether a shooting end instruction, such as the mode selection from the shooting mode to another mode, has been made. The CPU 13 repeats the processes starting from Step S201 until the shooting end instruction is made. Upon the shooting end instruction, the CPU 13 ends the process in accordance with the flowchart.

In the present embodiment, the CPU 13 should proceed to Step S209 when the judgment at Step S206 is NO. However, the CPU 13 may proceed to Step S208. In this case, even when the registered face image is not contained in the shot image, the number of the shot images for the registered person should be displayed every time shooting is performed. This enables prompting the user to early perform shooting of persons registered in advance.

Furthermore, the time point when the CPU 13 executes the number of non-shot images display at Step S208 is not limited to the time immediately after the shooting process. Instead, the time point may be other time points, such as when the power is turned ON, the time point when the shooting mode is set for the first time of the day, the shutter key is operated for the first time of the day. In addition, display of the number of the shot images at Step S208 is not limited to superimposing as shown in FIG. 6B. Instead, the number of the shot images may be displayed in the side or in another display form.

### C. Third Embodiment

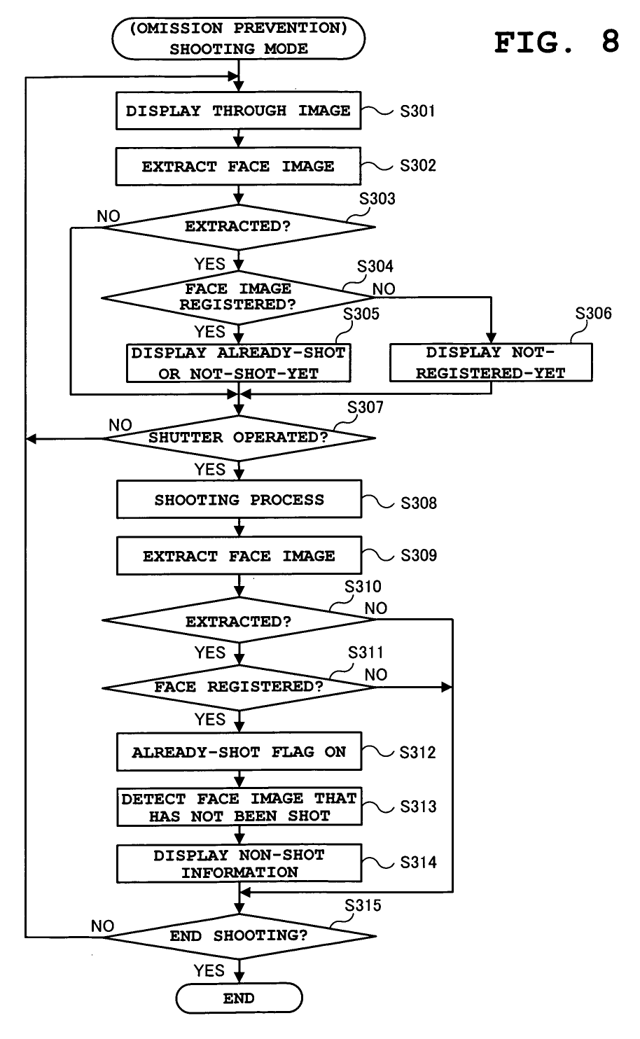

FIG. 8 is a flowchart showing the process procedure of the shooting mode process according to a third embodiment of the present invention. Note that, the face image registration table 111 in the embodiment is similar to that of the first embodiment as shown in FIG. 2C, and the already-shot flag F is provided for each registration area. In addition, in the flowchart of FIG. 8, the processes at Steps S307 to S315 are identical with the processes at Steps S102 to S110 in the flowchart of the first embodiment shown in FIG. 4. Accordingly, in the case where the registered face image is contained in the shot image recorded in the memory card 18, the already-shot flag F of the registered face images judged to be contained is turned ON in the face image registration table 111 by the process at S312 which is the identical process as Step S107.

In the present embodiment, the CPU 13 displays a through image in the display section 14 (Step S301), and extracts a face image from the through image that is displayed in the display section 14 (Step S302). Extraction of the face image may be performed by means of the extraction process as explained at Step S104.

In addition, the CPU 13 judges whether a face image has been extracted by this extraction process (Step S303). When judged that a face image has not been extracted, the CPU 13 proceeds to Step S307. When judged that a face image has been extracted, the CPU 13 judges whether the extracted face image is a registered face image through comparison between the extracted face image and the face image registered in the face image registration table 111 (Step S304). When judged that the extracted face image is a registered face image, the CPU 13 executes the already-shot or not-shot-yet display process (Step S305).

As described above, when a registered face image is contained in the shot image recorded in the memory card 18, the already-shot flag F for the registered face image which is judged to be contained is in the ON state in the face image registration table 111. Accordingly, the user can distinguish whether the face image extracted from the through image (registered face image) has already been shot or has not yet been shot by referring to the already-shot flag F in the face image registration table 111.

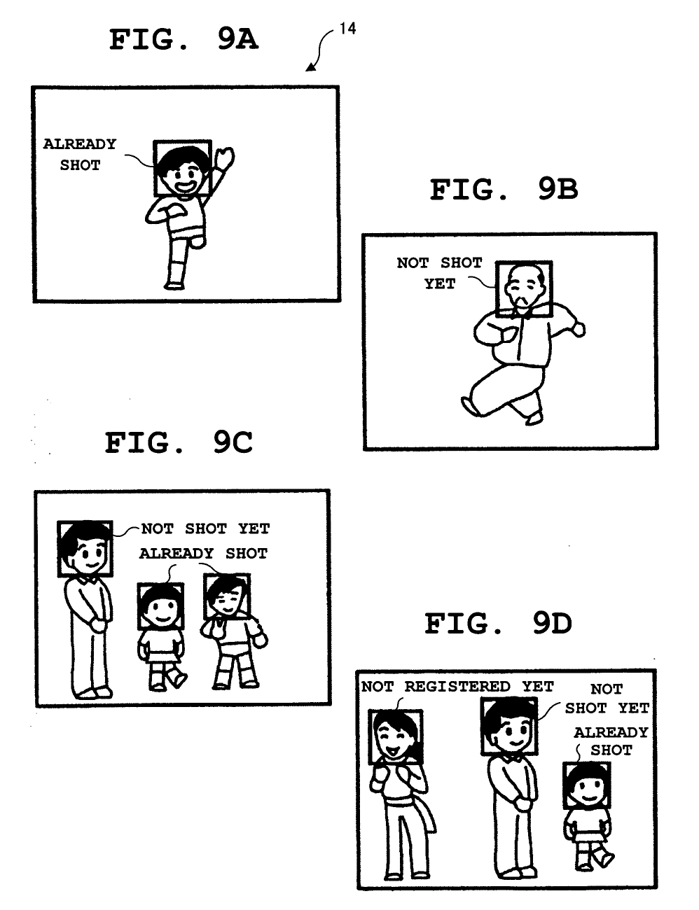

Next, when the face image has been already shot, as shown in FIG. 9A, the CPU 13 displays a frame that surrounds the face image that has been extracted at the above-described Step S302 and the characters “ALREADY SHOT” on the through image displayed in the display section 14. On the other hand, when the image has not yet been shot, as shown in FIG. 9B, the CPU 13 displays the frame that surrounds the face image extracted at the above-described Step S302 and the characters “NOT SHOT YET”. After this, the CPU 13 judges whether the shutter key has been operated (Step S307), and repeats the processes starting from Step S301 until the shutter key is operated.

Accordingly, a plurality of face images is extracted from the through image through repetition of the processes starting from S301. When the plurality of face images extracted are registered face images, the process at Step S305 should be executed on the individual face images. Therefore, in the case where a plurality of face images are extracted from the through image and the plurality of face images extracted are registered face images, the frame that surrounds the face image and characters either of “ALREADY SHOT” or “NOT SHOT YET” are displayed for each face image, as shown in FIG. 9D.

Thus, the user who has recognized by viewing the through images such as in FIG. 9A, FIG. 9B, FIG. 9C, can distinguish the person who has not been shot and the person who has already been shot before operating the shutter key. As a result, the user can perform shooting of the persons registered in advance more reliably and without omission.

On the contrary, when the judgment at Step S304 is NO, that is, when the extracted face image is not a registered face image, the CPU 13 executes the not-registered-yet display (Step S306). The not-registered-yet display, as shown in FIG. 9D, is executed by displaying the frame that surrounds the face image extracted at the above-described Step S302 and the characters “NOT REGISTERED YET”.

Accordingly, in the case where the user who has recognized by viewing the not-registered-yet display judges that the user does not need to shoot the person who has not been registered, the user can shoot an image from which the person who has not been registered is excluded by changing the angle of view or the like. Alternatively, the user can newly register the face image of the person who has not been registered in the face image registration table 111 by changing the setting to the face image registration mode.

Note that, to ensure discrimination, it is preferable to display the frames that surround the individual face images and the characters in different colors, depending on “already shot”, “not shot yet” and “not registered yet”.

### D. Fourth Embodiment

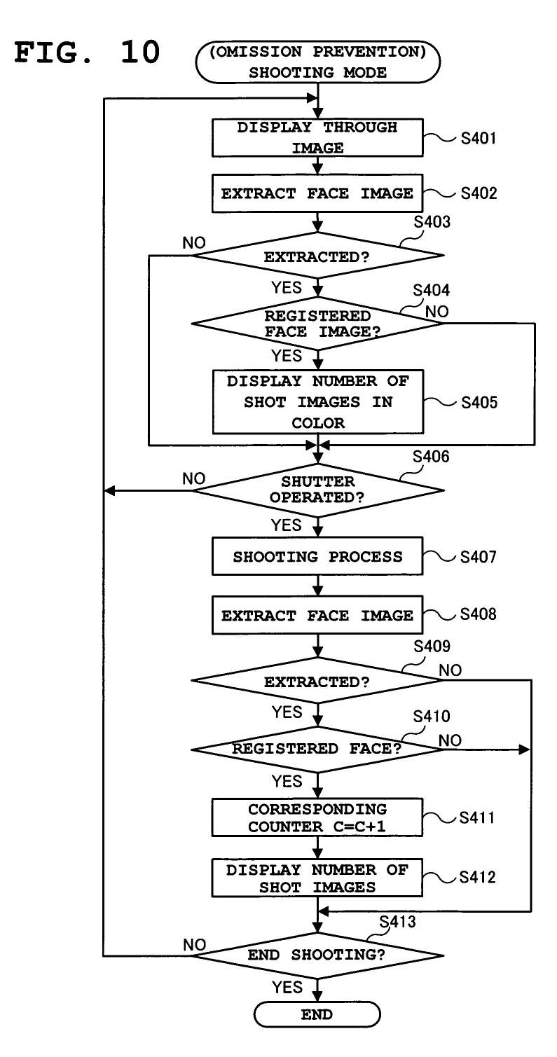

FIG. 10 is a flowchart showing the process procedure of the shooting mode process according to a fourth embodiment of the present invention. Note that, the face image registration table 111 in the embodiment is similar to that of the second embodiment shown in FIG. 6A, and the counter C is provided for each registration area. In addition, the processes at Steps S406 to S413 in the flowchart of FIG. 10 are identical with the processes at Steps S202 to S209 in the flowchart of the second embodiment shown in FIG. 7. Accordingly, when a registered face image is contained in the shot image recorded in the memory card 18, the CPU 13 counts up the counter C of the registered face image, which is judged to be contained in the face image registration table 111, by the process at S411 that is identical with the process at Step S207. Therefore, the counter C of each registered face image indicates the number of the shot images containing the registered face image.

In the present embodiment, the CPU 13 displays a through image in the display section 14 (Step S401), and further extracts a face image from the through image displayed in the display section 14 by the extraction process (Step S402). In addition, the CPU 13 judges whether a face image has been extracted by the extraction process (Step S403). When judged that a face image has not been extracted, the CPU 13 proceeds to Step S406. When judged that a face image has been extracted, the CPU 13 judges whether the extracted face image is a registered face image through comparison between the extracted face image and the face image registered in the face image registration table 111 (Step S404). When judged that the extracted face image is a registered face image, the CPU 13 executes the number of shot images color display process (Step S405).

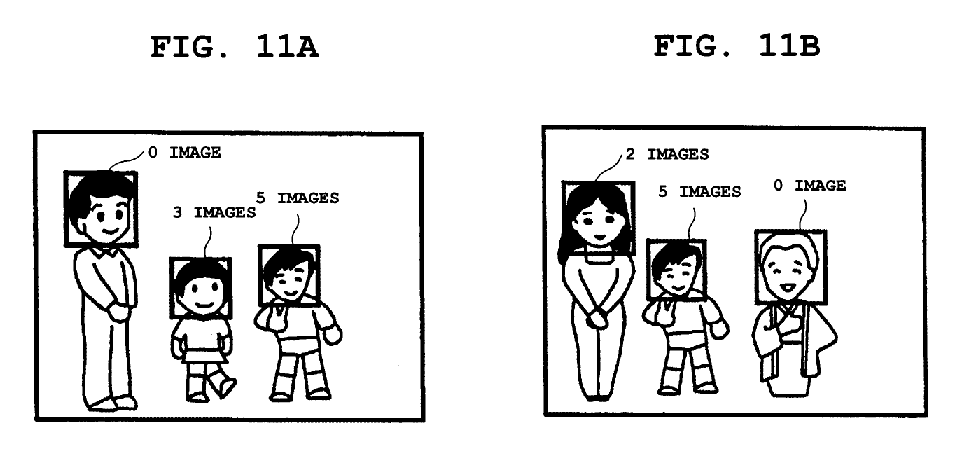

As described above, the counter C of each registered face image indicates the number of the shot images containing the registered face image. Accordingly, the CPU 13 detects the number of shot images for the face image (registered face image) extracted from the through image by referring to the counter C of each registered face image. Then, the CPU 13 displays the frame that surrounds the face image extracted at Step S402 as shown in FIG. 11A, FIG. 11B, and displays the characters indicating the number of the shot images in colors according to the number of the shot images. After this, the CPU 13 judges whether the shutter key has been operated (Step S406), and repeats the processes starting from Step S401 until the shutter key is operated.

Accordingly, a plurality of face images is extracted from the through image through repetition of the processes starting from Step S401. When the plurality of face images extracted are registered face images, the process at Step S405 should be executed on each of the face images. Therefore, in the case where a plurality of face images are extracted from the through image and the plurality of face images extracted are the registered face images, the frame that surrounds the face image and the character indicating the number of the shot images with a color according to the number of the shot images are displayed for each face, as shown in FIG. 11A and FIG. 11B.

The characters indicating the number of the shot images with colors according to the number of the shot images are, for example, as follows:

0: not shot yet—displayed in red;

1 to 2: already shot but with small number of the shot images —displayed in yellow; and

3 or more: already shot with sufficient number of the shot images—displayed in blue.

Thereby, the user who has recognized by viewing these colored numbers of the shot images can recognize shooting priority based on a color and a numerical value. This enables the user to perform shooting of persons registered in advance evenly and without omission.

Therefore, according to the first and second embodiments, the user can perform shooting of persons registered in advance without omission, while performing an ex-post check which is the check after shooting. According to the third and fourth embodiments, the user can perform shooting of persons registered in advance without omission, while performing a prior check that is a check before shooting.

### E. Fifth Embodiment

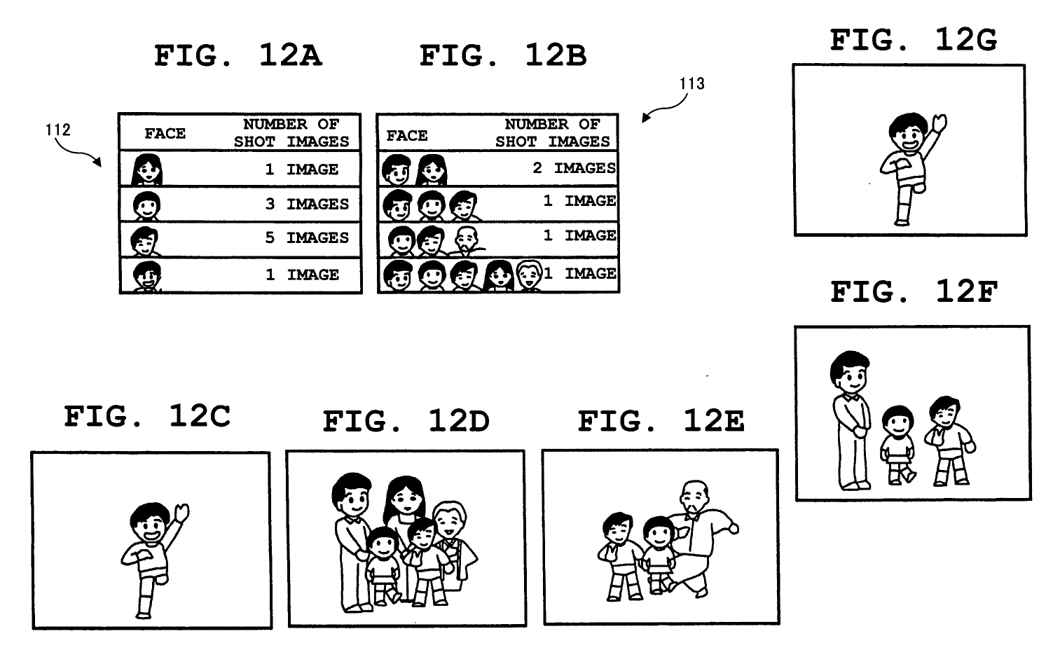

FIG. 12A and FIG. 12B are diagrams showing a memory configuration according to a fifth embodiment of the present invention. In the present embodiment, the flash memory 11 is provided with a memory for number of shot images of single face 112 as shown in FIG. 12A and a memory for number of shot images of combination of faces 113 as shown in FIG. 12B. The memory for number of shot images of single face 112 refers to a memory that stores the face image and the number of the shot images therefor in the case where face images for a single person stored in the face image registration table 111 is present in the shot image. The memory for number of shot images of combination of faces 113 refers to a memory that stores a combination of the face images and the number of the shot images for the combination in the case where the face image of a certain plurality of persons stored in the face image registration table 111 is present in the shot image.

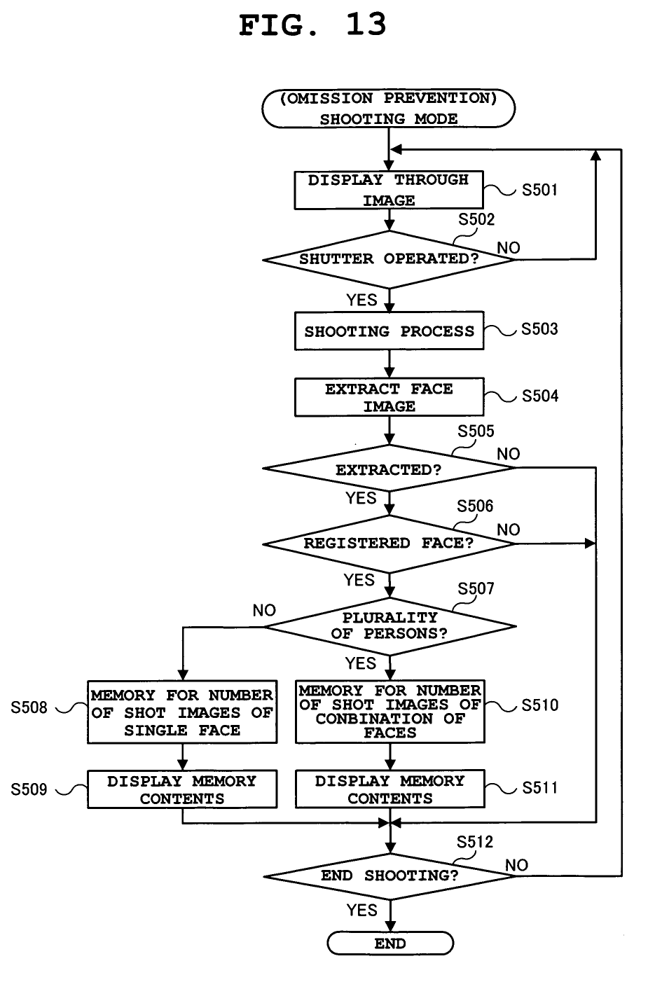

FIG. 13 is a flowchart showing the process procedure of the shooting mode process in the present embodiment. When the user sets a mode to the omission prevention shooting mode or the ordinary shooting mode, the CPU 13 runs in accordance with the program as described above, thereby executing the processes as shown in the flowchart. Specifically, the CPU 13 displays a through image based on an image data that has been loaded from the CCD 4 and accumulated in the DRAM 10 and which is equivalent to the amount of 1 frame (screen) in the display section 14 (Step S501). Next, the CPU 13 judges whether the shutter key has been operated (Step S502). When the shutter key has been operated, the CPU 13 executes the shooting process (Step S503), and records the JPEG-compressed image data in the memory card 18.

Next, the CPU 13 executes the face image extraction process as described above to extract the face image from the shot images that are the image data recorded in the memory card 18 (Step S504). At this time, in the case where a plurality of face images is present, the CPU 13 extracts all face images. In addition, the CPU 13 judges whether at least one face image has been extracted by the process at Step S504 (Step S505). When judged that a face image has not been extracted, the CPU 13 proceeds to Step S512. When judged that a face image has been extracted, the CPU 13 judges whether the extracted face image is contained in a registered face image registered in the face image registration table 111 (Step S506).

Next, when the registered face image is not contained in the shot image which has just been recorded this time in the memory card 18 (Step S506; NO), the CPU 13 proceeds to Step S512 without executing the processes at Step S507 to S511. On the other hand, when the registered face image is contained in the shot image which has just been recorded this time in the memory card 18, the CPU 13 judges whether a plurality of registered face images are contained, that is, whether the image is shot for a plurality of registered persons (Step S507). When judged that the image is shot for a single registered person rather than for a plurality of registered persons, the CPU 13 updates the memory for number of shot images of single face 112 (Step S508).

In the case where the registered person is shot for the first time, and the face image thereof has not been stored in the memory for number of shot images of single face 112, the CPU 13 writes the face image of the registered person it has read out from the face image registration table 111 and the number of the shot images “ONE IMAGE” in the memory for number of shot images of single face 112, and updates this. Accordingly, as shown in FIG. 12C, in the case where a single registered person is shot, and the face image thereof has not been stored in the memory for number of shot images of single face 112, the face image of the registered person and the number of the shot images “ONE IMAGE” is written in the memory for number of shot images of single face 112 as shown in FIG. 12A. Alternatively, in the case where the registered person is shot again, and the face image thereof has already been stored in the memory for number of shot images of single face 112, the number of the shot images corresponding to the face image is incremented.

Next, the CPU 13 executes a memory contents display process to display the contents stored in the memory for number of shot images of single face 112 in the display section 14 (Step S509). As a result of this, the number of the shot images is displayed in the display section 14 corresponding to the face image, as shown in FIG. 12A.

Accordingly, the user who has recognized by viewing this can recognize shooting priority in shooting of a single person based on the number of the shot images corresponding to the face image and can perform shooting of a single person registered in advance evenly and without omission.

On the other hand, when judged, at Step S507, that the image is shot for a plurality of registered persons, the CPU 13 updates the memory for number of shot images of combination of faces 113 (Step S508). Specifically, in the case where the combination of the registered persons is shot for the first time and this combination of the face images has not been stored in the memory for number of shot images of combination of faces 113, the CPU 13 writes the face images of the plurality of registered persons it has read out from the face image registration table 111 and the number of the shot images “ONE IMAGE” in the memory for number of shot images of combination of faces 113, and updates this. FIG. 12D shows the shot image for the combination of the registered persons as shown in the fourth stage (lowermost stage) of FIG. 12B. FIG. 12E shows the shot image for the combination of the registered persons as shown in the third stage of FIG. 12B. FIG. 12F shows the shot image for the combination of the registered persons in the second stage of FIG. 12B. FIG. 12G shows the shot image for the combination of the registered persons in the first stage (uppermost stage) of FIG. 12B. Accordingly, as shown in FIG. 12D, FIG. 12E, FIG. 12F, in the case where the registered persons are shot in a combination and this combination of the face images has not been stored in the memory for number of shot images of combination of faces 113, the CPU 13 writes the face images for the combination of the registered persons and the number of the shot images “ONE IMAGE” in the memory for number of shot images of combination of faces 113 as shown in FIG. 12B. In addition, in the case where the registered persons in the combination are shot again and the face images thereof have already been stored in the memory for number of shot images of single face 112 as shown in FIG. 12G, the number of the shot images corresponding to the face image is incremented.

Next, the CPU 13 executes the memory contents display process so as to display the contents stored in the memory for number of shot images of combination of faces 113 in the display section 14 (Step S511). As a result of this, the number of the shot images corresponding to the combination of the face images is displayed in the display section 14 as shown in FIG. 12B.

Accordingly, the user who has recognized by viewing this can recognize shooting priority in shooting of the combination based on the number of the shot images corresponding to the combination of the face images, and can perform shooting of the combination of the persons registered in advance evenly and without omission.

Note that, only the contents of the memory for number of shot images of single face 112 and the contents of the memory for number of shot images of combination of faces 113 should be displayed respectively, in the contents display processes at Step S509 and Step S511. However, the contents of the memory for number of shot images of single face 112 and the contents of the memory for number of shot images of combination of faces 113 may be displayed on the same screen, and may be displayed in time division manner.

In addition, in the present embodiment, the case where only a single registered person or a plurality of registered persons present in the shot image is indicated. However, even in the case where a person who has not been registered is contained in the shot image, the process in accordance with the flowchart can be used to address this case.

### F. Sixth Embodiment

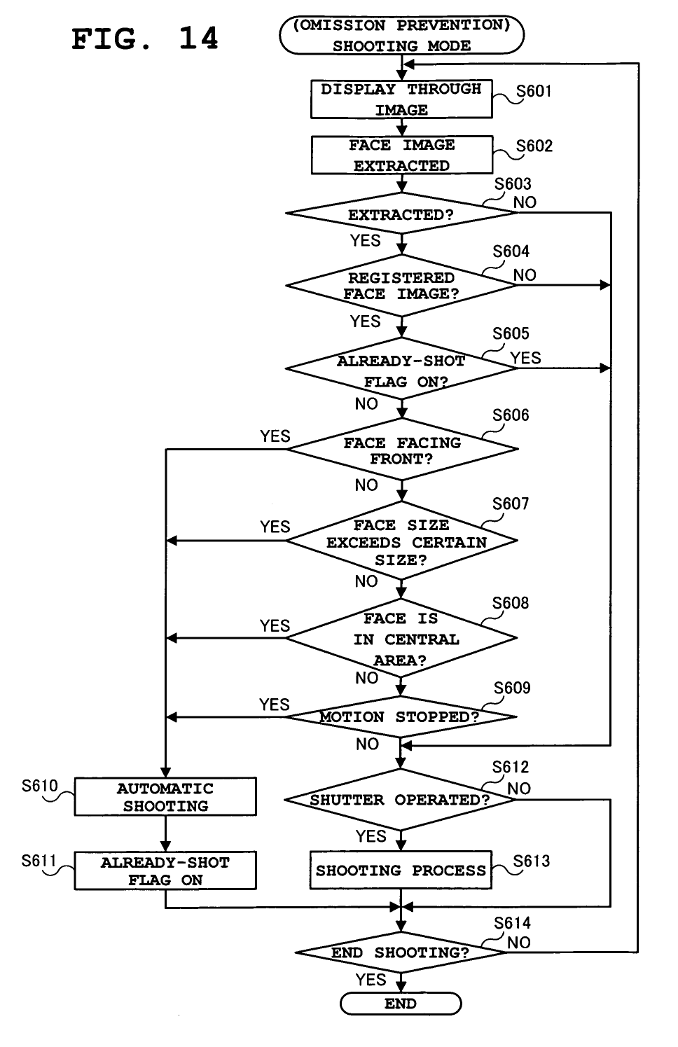

FIG. 14 is a flowchart showing the process procedure of the shooting mode process according to a sixth embodiment of the present invention. Note that, the face image registration table 111 in the embodiment has the same form as the first embodiment as shown in FIG. 2C, and an already-shot flag F is provided for each registration area.

In the present embodiment, the CPU 13 displays a through image in the display section 14 (Step S601), and extracts the face image from the through image displayed in the display section 14 (Step S602). This extraction of the face image may be performed by the extraction process as explained at Step S104.

In addition, the CPU 13 judges whether a face image has been extracted by this extraction process (Step S603). When judged that a face image has not been extracted, the CPU 13 proceeds to Step S612. When judged that a face image has been extracted, the CPU 13 judges whether the extracted face image is a registered face image through comparison between the extracted face image and the face image which is registered in the face image registration table 111 (Step S604). When judged that the extracted face image is not a registered face image, the CPU 13 proceeds to Step S612. When judged that the extracted face image is a registered face image, the CPU 13 judges whether the face image has already been shot based on whether the corresponding already-shot flag F is in the ON state (Step S605). When judged that the corresponding already-shot flag F is in the ON state, that is, when judged that the face image has already been shot, the CPU 13 proceeds to Step S612.

On the other hand, when judged that the corresponding already-shot flag F is in the OFF state, that is, when judged that the face image has not been shot yet, the CPU 13 judges, separately, whether the face in the through image judged as a registered face faces the front (Step S606), whether the face has exceeded a certain size in the through image (Step S607), whether the face is present in a central area in the through image (Step S608), and whether motion of the subject having the above-described face has stopped (Step S609).

Furthermore, at the time of judgment at Step S609, the CPU 13 observes, for example, a block comprising a plurality of pixels for the subject having the above-described face, and calculates the motion vector in the frame image before and after this observed block. Then, the CPU 13 judges that motion has stopped when the magnitude of this motion vector becomes substantially “0”.

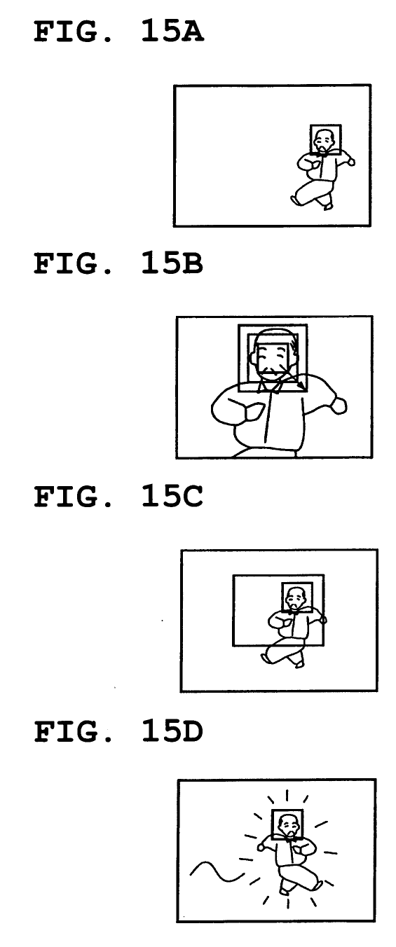

Next, in the case where judgment at either one of Steps S606 to S609 becomes YES, the CPU 13 executes the automatic shooting (Step S610) and records the JPEG-compressed image data in the memory card 18. Accordingly, as shown in FIGS. 15A to FIG. 15D, the automatic shooting is executed in either one of the following cases: where the face faces the front (FIG. 15A), where the size of the face has exceeded a certain size (FIG. 15B), where the face is within the central area of the screen (FIG. 15C), and where motion of the subject has stopped (FIG. 15D). As a result of this, the shot image in which the registered person is clearly shot can be recorded.

Furthermore, the automatic shooting is executed only on the registered person for whom the already-shot flag F is in the OFF state, that is, who has not been shot yet. Because of this, the number of the shot images of a particular person does not excessively increase, and the numbers of the shot images for the individual registered persons can be recorded. Therefore, the user can record the images in which each of the registered persons is shot clearly and without omission.

In addition, when the automatic shooting is executed, the CPU 13 turns ON the already-shot flag and proceeds to Step S614. On the other hand, at Step S612 that follows in the case where the judgments at either Step S603, S604, S609 is NO, or the judgment at S605 is YES, the CPU 13 judges whether the shutter key has been operated. When judged that the shutter key has been operated, the CPU 13 executes the shooting process (Step S613). Accordingly, manual shooting can also be performed by operation of the shutter key.

Next, at Step S614 that follows in the case where the judgment at Step S612 is NO, that is, the shutter key has not been operated, and that follows Step S611 and Step S613, the CPU 13 judges whether the shooting end instruction, such as the mode selection from the shooting mode to another mode, has been made. The CPU 13 repeats the processes starting from Step S601 until the shooting end instruction is made. Upon the shooting end instruction, the CPU 13 ends the process in accordance with the flowchart.

Note that, in the present embodiment, the CPU 13 should judge at Step S605 whether the face image has been already shot based on the state of the already-shot flag, and execute the automatic shooting when judged that the face image has not been shot yet. However, the CPU 13 may judge at Step S605 whether the number of the shot images is not more than a predetermined number of images based on the above-described value of the counter C, and execute the automatic shooting when judged that the number of the shot images is not more than the predetermined number of the images.

As a result of this, the user can record the images in which each of the registered persons is shot without omission, in the equal number of images, and clearly.

In addition, in the present embodiment, the CPU 13 should display a through image at Step S601. However, the CPU 13 may, without displaying a through image, execute the processes at Steps S602 to S611 and Step S614 only.

In addition, in the individual embodiments, explanation is given on the case where a face image of a person is used as the registered image. However, the registered image is not limited to the face image, and instead any subject may be used as the registered image.

Note that, the already-shot flag F and the counter C used in the individual embodiments may be reset when the process in the shooting mode process starts, when shooting in the shooting mode ends, or the like.

Furthermore, although the computer program product of the imaging apparatus which is a preferred embodiment of the present invention is stored in the memory (for example, ROM, etc.) of the imaging apparatus, this processing program is stored on a computer-readable medium and should also be protected in the case of manufacturing, selling, etc. of only the program. In that case, the method of protecting the program with a patent will be realized by the form of the computer-readable medium on which the computer program product is stored.

While the present invention has been described with reference to the preferred embodiments, it is intended that the invention be not limited by any of the details of the description therein but includes all the embodiments which fall within the scope of the appended claims.

What is claimed is:

1. An imaging apparatus comprising:
a subject memory section which stores a subject;
an imaging section which shoots an image;
an image recording section which records an image shot by the imaging section;
a judging section which judges a state in which an image containing the subject stored in the subject memory section is recorded in the image recording section; and
a display section which displays a result of being judged by the judging section.

2. The imaging apparatus according to claim 1, wherein the subject memory section stores a plurality of subjects, and the display section displays the result of being judged by the judging section in a manner that the result corresponds to the plurality of subjects.

3. The imaging apparatus according to claim 1, wherein the judging section judges whether an image containing a subject that has been stored in the subject memory section stored in the image recording section, and the display section displays the result of being judged by the judging section on whether the image containing the subject has been stored.

4. The imaging apparatus according to claim 1, wherein the judging section includes a first counting section to counts the number of the images containing the subject stored in the image recording section, in the subject memory section, and the display section displays the number of the images detected by the first counting section.

5. The imaging apparatus according to claim 1, wherein the display section executes the display every time when the image is recorded in the image recording section.

6. The imaging apparatus according to claim 1, wherein the display section displays a through image based on an image imaged by the imaging section sequentially, and executes the display in the through image in a manner that the display corresponds to the subject stored in the subject memory section.

7. The imaging apparatus according to claim 6, wherein when a subject that has not been stored in the subject memory section is present in the through image, the display section executes display indicating that the subject has not been stored.

8. The imaging apparatus according to claim 2, the judging section includes a second counting section to counts the number of the images containing a combination of a plurality of subjects in the image recording section, and the display section displays the number of the images counted by the second counting section in a manner that the number corresponds to the combination of the plurality of subjects.

9. The imaging apparatus according to claim 8, wherein the second counting section additionally counts, in the image recording section, the number of the images containing a subject stored in the subject memory section, and the display section displays the number of the images additionally counted by the second counting section in a manner that the number corresponds to the single subject.

10. The imaging apparatus according to claim 1, further comprising:
an acquiring section to acquires an image shot by the imaging section in response to an operation; and
a memory controlling section to extracts the subject from the image acquired by the acquiring section and storing the subject in the subject memory section.

11. An imaging apparatus comprising:
a subject memory section which stores a subject;
an imaging section which shoots;
an image recording section which records an image;
a first judging section which judges whether an image containing a subject stored in the subject memory section has been stored in the image recording section;
a second judging section which judges whether a subject stored in the subject memory section is present in an image which is shot by the imaging section; and
a recording control section which acquires the image shot by the imaging section and records the image in the image recording section, when judged that the subject is present by the second judging section and judged that an image containing the subject has not been stored in the image recording section by the first judging section.

12. The imaging apparatus according to claim 11, wherein the subject memory section stores a plurality of subjects separately.

13. The imaging apparatus according to claim 11, wherein the recording control section includes a shape judging section which judges whether the subject in the image shot by the imaging section has a predetermined shape, and the recording control section acquires the image shot by the imaging section and records the image in the image recording section when judged the that the subject has a predetermined form by the shape judgment section.

14. The imaging apparatus according to claim 11, further comprising:
an acquiring section for acquiring the image shot by the imaging section in response to an operation; and
a memory control section which extracts the subject from the image acquired by the acquisition section and stores the subject in the subject memory section.

15. The imaging apparatus according to claim 13, wherein the display section displays a list of the subjects that have been stored in the subject memory section.

16. A computer-readable storage medium having a program of an imaging apparatus including a subject memory section which stores a subject, an imaging section which shoots, and an image recording section which records an image shot by the imaging section stored thereon that is executable by a computer, comprising:
a judgment process which judges a state in which an image containing the subject stored in the subject memory section is recorded in the image recording section; and
a display control process which displays a result of being judged by the judging process.

17. A display control method in an imaging apparatus including a subject memory section which stores a subject, an imaging section for shoots; and an image recording section which records an image shot by the imaging section, the method comprising:
a judging step which judges a state in which an image containing the subject stored in the subject memory section is recorded in the image recording section; and
a display step which displays the result detected by the detection step.

18. A display control method for detecting an image containing a registered subject from a recording section for recording an image, and displaying a result of detection for each registered subject.
